(19) United States
(12) Patent Application Publication
(10) Pub. No.: US 2023/0102594 A1
(43) Pub. Date: Mar. 30, 2023

(54) CODE PAGE TRACKING AND USE FOR INDEXING AND SEARCHING

(71) Applicant: International Business Machines Corporation, Armonk, NY (US)

(72) Inventors: Peng Hui Jiang, Beijing (CN); Jun Su, Beijing (CN)

(21) Appl. No.: 17/487,404

(22) Filed: Sep. 28, 2021

(51) Int. Cl. G06F 16/31; G06F 16/383; G06F 16/33; G06F 16/338

(52) U.S. Cl. CPC G06F 16/328; G06F 16/383; G06F 16/3334; G06F 16/338

(57) ABSTRACT

A processor may determine indexing information for indexing a document. The indexing information may comprise at least one index extracted from the document. The processor may identify at least one code page associated with the document. The processor may store the indexing information in association with code page information indicating the at least one code page. In response to a search query, the processor may determine a relevance degree between the document and the search query based on the indexing information and the code page information.

### BACKGROUND

The present disclosure relates generally to the field of computer techniques, and more specifically, to code page tracking and use for indexing and searching.

With the increase of information transmission, indexing and searching are important techniques to discover useful and feasible information for a user. To search for information from a plurality of documents, indexing information may be needed for the plurality of documents to facilitate the searching. Nowadays, as massive amounts of data are available, search engines may need to index hundreds of millions or even tens of billions of documents in. Faced with such massive amounts of data, the way the documents are indexed is a key point to facilitate discovery of the relevant documents effectively.

### SUMMARY

Embodiments of the present disclosure include a method, computer program product, and system for code page tracking and use for indexing and searching. A processor may determine indexing information for indexing a document. The indexing information may comprise at least one index extracted from the document. The processor may identify at least one code page associated with the document. The processor may store the indexing information in association with code page information indicating the at least one code page. In response to a search query, the processor may determine a relevance degree between the document and the search query based on the indexing information and the code page information.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a cloud computing node in accordance with some aspects of the present disclosure.

FIG. 2 illustrates a cloud computing environment, in accordance with some aspects of the present disclosure.

FIG. 3 illustrates abstraction model layers, in accordance with some aspects of the present disclosure.

FIG. 4 is a block diagram of a system for indexing and searching in accordance with some aspects of the present disclosure.

FIG. 5 illustrates exemplary identified code pages associated with the document in accordance with some aspects of the present disclosure.

FIG. 6A illustrates exemplary processes of building indexing information and code page information for documents in accordance with some aspects of the present disclosure.

FIG. 6B illustrates exemplary processes of building indexing information and code page information for documents in accordance with some aspects of the present disclosure.

FIG. 6C illustrates exemplary processes of building indexing information and code page information for documents in accordance with some aspects of the present disclosure.

FIG. 7 is a block diagram of a system for indexing and searching, in accordance with some other aspects of the present disclosure.

FIG. 8A illustrates exemplary searching processes, in accordance with some other aspects of the present disclosure.

FIG. 8B illustrates exemplary searching processes, in accordance with some other aspects of the present disclosure.

FIG. 9 is a flowchart of an exemplary method, in accordance with some aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of computer techniques, and more specifically, to code page tracking and use for indexing and searching. While the present disclosure is not necessarily limited to such applications, various aspects of the disclosure may be appreciated through a discussion of various examples using this context.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

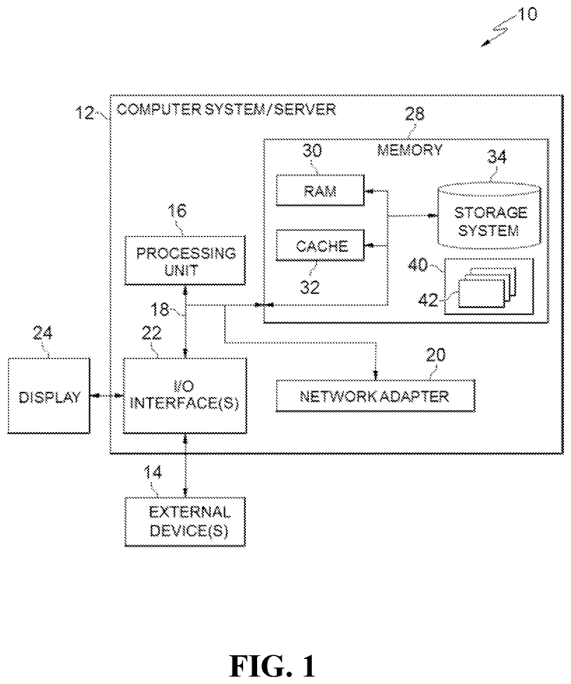

Referring now to FIG. 1, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

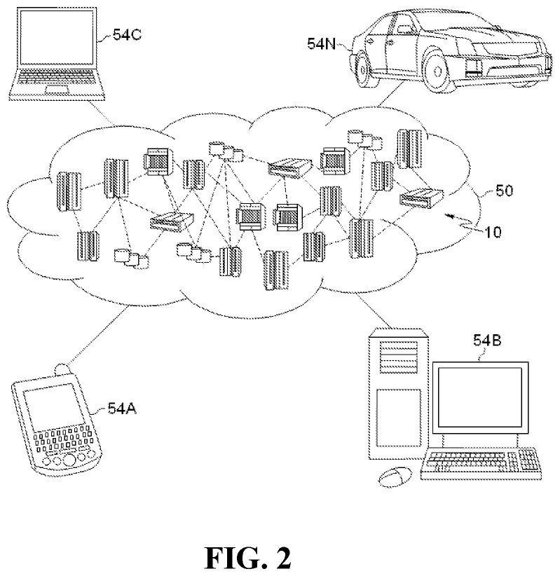

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

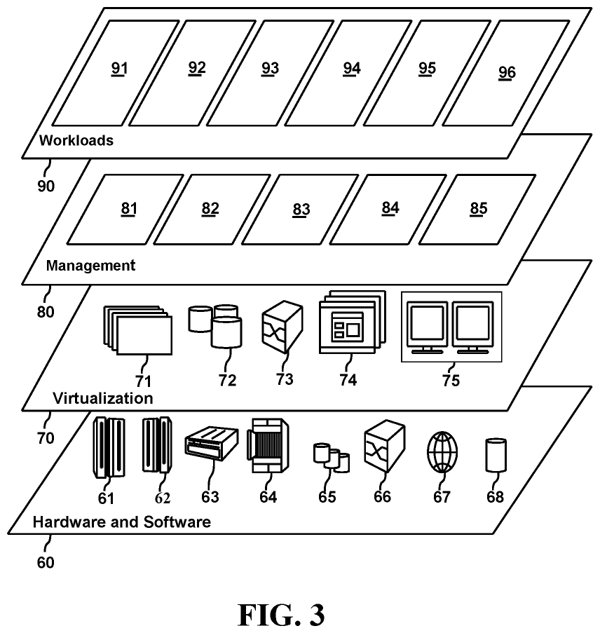

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and indexing and searching 96. The functionalities of indexing and searching 96 will be described in the following embodiment of the present disclosure.

In the computer science field, terms “code page”, “character set,” “character map”, and “character encoding” were historically synonymous, as the same standard would specify a repertoire of characters and how they were to be encoded into a stream of code units—usually with a single character per a code unit. The terms now are related but with distinct meanings, reflecting the efforts of standard bodies to use precise terminology when unifying many different encoding systems. Regardless, the terms are still used interchangeably, with character sets being nearly ubiquitous. Some example code pages may include but are not limited to Windows-1250, UCS-4, ISO-8859-1, ISO-8859-2, UTF-7, UTF-8, UTF-16, UTF-32, IBM852, GB18030, ISO-2022-JP, and so on.

In the character encoding terminology, a code point or code position is any of numerical values that make up a code space. A code page may be a table defining a plurality of code points for different characters or words. A code point may be defined as a specific sequence of bits, used to represent a specific character or word. For example, in UCS-4, code points are defined as 4-byte (octet) binary numbers (which is fixed-width and simple, but inefficient), while in UTF-8, characters are encoded as 1-4 byte numbers (which is variable-width, hence more efficient but more complex, and backward-compatible with ASCII).

In the computer science field, documents can be encoded with different code pages. Different code pages may be utilized depending on the settings of the computer systems, the display systems, the geographical areas, the languages used in the documents, and so on. When a document is transferred from one end to another end, it may be encoded and decoded, and then converted from one code page to another code page. For example, an email message may be generated and sent by a person in a first country, received by another person in a second country, and forwarded and archived in a third country. In those different areas, the email messages may be encoded using different code pages.

Generally, to index different documents for the purpose of searching by a search engine, a default code page may be chosen to encoding indexing information for those documents. To do so, the accuracy of hits of the documents may be ensured. However, the inventors found that such an indexing way may cause a loss of the nature of information in the documents, which may not also be beneficial for indexing and searching.

In accordance with embodiments of the present disclosure, there is provided a solution for code page tracking and use for indexing and searching. In this solution, indexing information and code page information for a document are both tracked. The code page information indicates one or more code pages associated with the document. In response to a search query, the indexing information and the code page information can be both used for determining a relevance degree between the document and the search query, so as to determine a query result for the search query.

By tracking the code page information together with the indexing information, it is possible to improve search accuracy with more suitable context. For example, to obtain a search result, users who are working on an encoding system of one code page may prefer the documents with the same or similar code pages than the documents encoded with other code pages, especially when there is a plurality of documents determined to have their indexing information matched with the search query.

Some example embodiments of the present disclosure will be described in detail with reference to the accompanying figures.

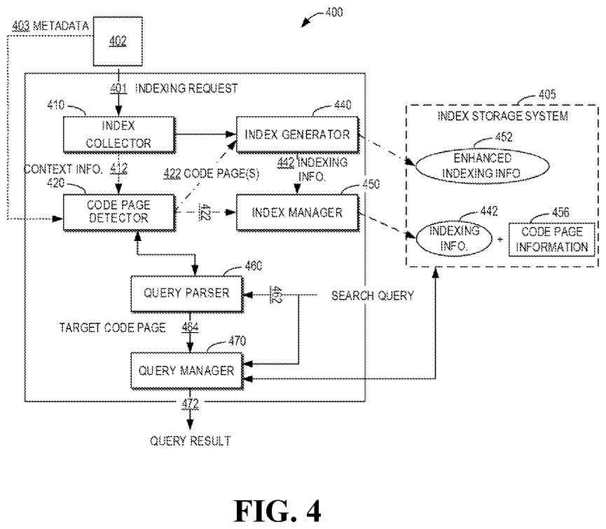

Reference is made to FIG. 4, which depicts a block diagram of a system 400 for indexing and searching in accordance with some embodiments of the present disclosure. As illustrated, the system 400 is configured to build indexes for one or more documents and to perform searching responsive to a search query. As used herein, a document may be an electronic file of any format, such as a PDF file, a MICROSOFT Office file, a web page, an email message, an electronic image, and the like.

The system 400 comprises an indexing part and a searching part. The indexing part of the system 400 comprises one or more components for determining indexing information for indexing a document and code page information for indicating one or more code pages associated with the document, and one or more components for storing the indexing information in association with code page information indicating the one or more code pages. The searching part of the system 400 comprises one or more components for performing searching in response to a search query.

The code page information may be tracked when indexing a new document. As illustrated, the system 400 may comprise an index collector 410 configured to collect information for indexing a document 402 in response to an indexing request 401, a code page detector 420 configured to identify one or more code pages 422 associated with the document 402, an index generator 440 configured to generate indexing information, and an index manager 450 configured to store generated indexing information in association with code page information. It should be appreciated that although one document is illustrated, the system 400 may be configured to perform indexing for a plurality of documents in a similar manner as discussed herein.

Generally, the document 402 may be currently encoded using a certain code page. In particular, words and/or characters contained in document 402 may be encoded with code points defined by the code page. In some cases, the document 402 may be historically encoded using one or more different historical code pages. The document 402 may be converted from one code page to another code page if it is transferred from one end to another end that operates with a different code page encoding system. Therefore, in some cases, one or more historical code pages may also be useful, as those code pages together with the current code page can show the code page conversion for the document 402.

In some embodiments, to identify the code page(s) 422 associated with the document 402, the code page detector 420 may identify the current code page and/or the one or more historical code pages used for encoding the document 402. There may be various ways to determine the code page(s) currently and/or historically used for encoding the document 402. In some embodiments, the index collector 410 may be configured to collect context information 412 and provide the context information 412 to the code page detector 414 for use in determining the code page(s) associated with the document 402.

The context information 412 may be associated with the indexing request 401, a requestor who initiates the indexing request, and/or the document 402. In some embodiments, the context information 412 may indicate an Internet Protocol (IP) address or a geographical area (such as a country or a region) from which the indexing request 401 is received, information about a computer system or a browser from which the indexing request 401 is received, and/or other information. As different code pages may be typically utilized in different countries and/or regions, the context information associated with the indexing request 401 may be used to determine the country or region and then determine the current code page utilized there. The information about the computer system or the browser may also indicate or facilitate identifying the current code page used for encoding the document 402.

In some embodiments, the context information 412 may additionally or alternatively indicate profile information about the requestor who initiates the indexing request 401, preference information of the requestor in terms of editing and/or reading documents, and so on. In some embodiments, the context information 412 may additionally or alternatively indicate context about the document 402, such as a format of the document 402 (an Office file, PDF file, or the like), information about the editing tool used to edit or present the document 402, a transfer path of the document 402, and/or the like. The context information about the requestor and/or the document 402 may additionally or alternatively use the current code page and/or one or more historical code page(s) that are used for encoding the document 402.

As an alternative or in addition to the context information 412, the code page detector 420 may retrieve metadata 403 associated with the document 402 which may comprise information about the current code page and/or one or more historical code pages used for encoding the document 402. The metadata 403 may include various types of information related to the document 402, such as the author, the creation date, the update date, the format information, as well as the code page(s) currently and/or historically used for encoding the document 402. In such a case, the code page detector 420 may determine the current and/or historical code pages used for encoding the document 402 from the metadata 403.

In some applications, the system 400 may be configured to encode indexing information of documents using a same code page (referred to as an indexing code page). In some examples, the indexing code page may be configured as a default code page for the system 400. In this way, the indexing information for a plurality of documents may be encoded with the same code page to ensure the search efficiency and accuracy. The indexing code page used for encoding the indexing information may be the same or different from the current code page used for encoding the document 402. In some embodiments, if the default code page is different from the current code page used for encoding the document 402, the code page detector 420 may also track the default code page for the document 402.

It should be appreciated that although some embodiments for identifying associated code page(s) for a document have been provided above, the associated code page(s) may be determined in many other ways, such as manually specified. The scope of the present disclosure is not limited in this regard.

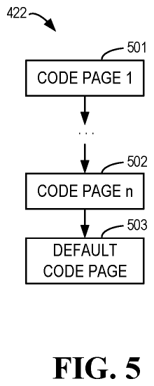

In some embodiments where the historical code page(s) and/or the default code page in addition to the current code page are identified, a code page chain may be formed for the document 402, which shows the code page conversion of the document 402. FIG. 5 illustrates an example of the identified code pages 422 associated with the document 402, which is in the form of a code page chain. As shown, the code page chain comprises a code page 501 (represented as “Code Page 1”) that is historically used for encoding the document 402, a code page 502 (represented as “Code Page n”) that is currently used for encoding the document 402, and an indexing code page 503 that is used for encoding the indexing information of the document 402.

Although not specifically illustrated in FIG. 5, the code page chain may include more than one historical code page associated with the document 402. In other examples, one or more historical code pages and/or the default code page may be omitted from the code page chain. For example, although it is found that the document 402 was previously encoded with a plurality of historical code pages, a predetermined number of the historical code pages may be recorded in the code page chain. The default code page may be omitted if it is the same as the current code page or if it can be easily identified from the encoding of the indexing information.

Reference is made back to FIG. 4. The code page detector 420 may provide the one or more identified code pages 422 associated with the document 402 to one or both of the index generator 440 and the index manager 450. As will be described in detail below, the identified code page(s) 422 may be recorded by the index generator 440 or the index manager 450 in association with indexing information determined for the document 402. The index generator 440 may be configured to generate indexing information 442 for the document 402. The indexing information 442 may be stored by the index generator 440 or the index manager 450 to an index storage system 405. The indexing information 442 is stored in association with code page information indicating the identified code page(s) 422, in order to facilitate the searching process. The functionalities of the index generator 440 and the index manager 450 will be discussed in detail below.

In addition to the context information 412 for identifying the code page(s) associated with the document 402, the index collector 410 may further be configured to extract information to generate indexing information for indexing the document 402. In some embodiments, the index collector 410 may extract one or more keywords from the document 402 used to build one or more indexes for the document 402. The index collector 410 may discard some unimportant words or characters in the document 402 that are not be useful for indexing the document 402.

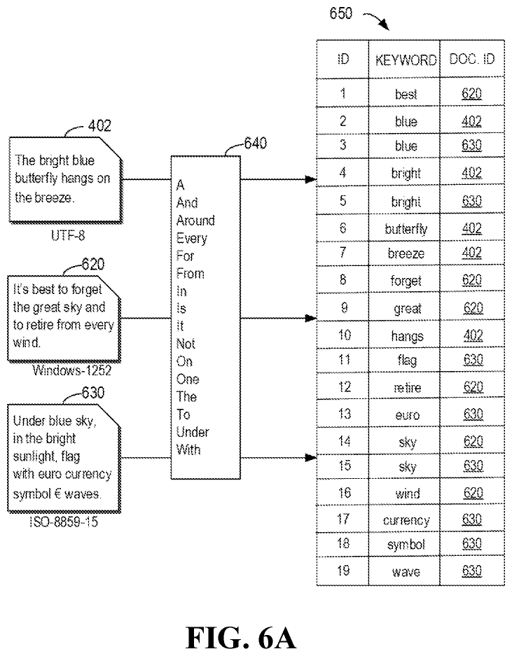

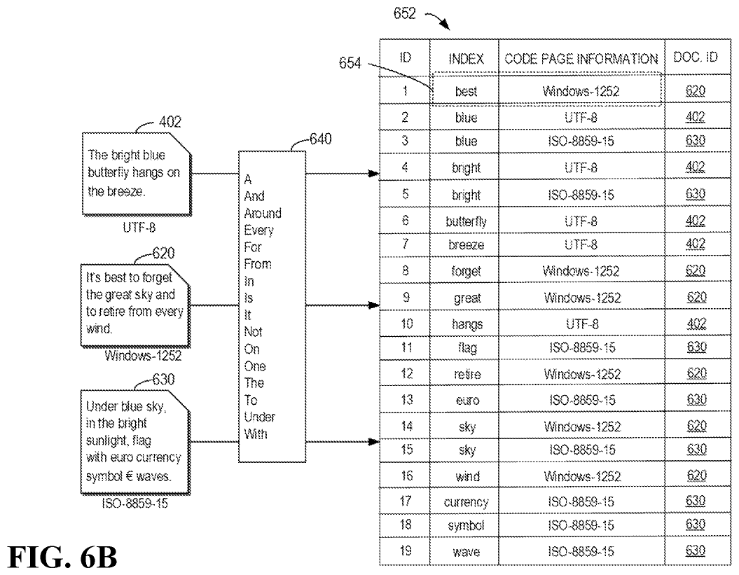

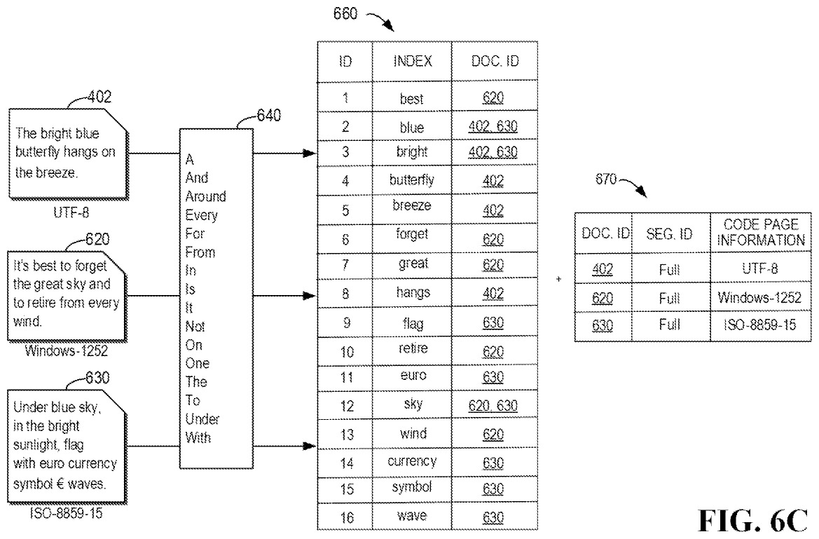

FIG. 6A depicts an example process of building indexing information for documents. In these examples, it is assumed that an example of the document 402 together with further documents 620 and 630 are to be indexed by the system 400. It should be appreciated that the words and characters shown in the examples of the documents 402, 620, and 630 are provided merely for the purpose of illustration. FIG. 6A also illustrates the respective code pages used for encoding the documents 402, 620, and 630. For example, the current code page for the document 402 is UTF-8, the current code page for the document 620 is Windows-1252, and the current code page for the document 630 is ISO-8859-15.

To facilitate build indexing information for a document, the index collector 410 may discard unimportant words in a reference list 640 from the document. In the example of FIG. 6A, the unimportant words in the reference list 640 may include stop words in English language. The index collector 410 may then collect other words in the document as keywords for indexing the document. FIG. 6A illustrates a table 650 containing a list of keywords collected from the documents 402, 620, and 630. The table 650 also records identification information of the document (represented as “Doc. ID”) from which a keyword is collected.

Referring back to FIG. 4, in some embodiments, if the document 402 is currently encoded using a code page different from the default code page used by the system 400 for encoding indexing information, the index collector 410 may convert current code points representing the keywords in the document 402 to corresponding code points in the indexing code page that is used for encoding the indexing information. The index collector 410 may provide the converted code points of the keywords in the document 402 to the index generator 440 to generate the indexing information 442. The indexing information 442 for the document 402 generally comprises one or more indexes, each comprising a keyword or a sequence of keywords extracted from the document.

In some embodiments, in order to associate the indexing information 442 with code page information indicating the identified code page(s), the index generator 440 may determine whether the code page information can be indexed using reserved bit spaces of the code points from the indexing code page used for encoding the indexing information 442. In some embodiments, for an index of the indexing information 442, the index generator 440 may determine whether there is a reserved field in the code points used to encoding the index.

Depending on a definition of a code page, some code points are defined in such a way that there are one or more bytes reserved for use. If the index generator 440 determines that there is one or more reserved fields in the code points used for encoding the index of the indexing information 442, the index generator 440 may encode the code page information into the reserved field(s) of the code points, to generate enhanced indexing information 452 for the document 402. An index with its reserved fields of the code points encoded with the code page information may be referred to as an enhanced index. The enhanced indexing information 452 for the document 402 may include one or more enhanced indexes. By encoding the code page information into the code points of the indexes, it will be easier to extract the associated code page(s) for the document 402 during the document searching, as will be discussed below.

In some embodiments, if more than one index is included in the indexing information 442 for the document 402, the index generator 440 may encode the code page information into the reserved fields of the code points encoding each or some of the indexes. As such, when performing document searching, the indexing information (e.g., the keywords in the indexes) and the code page information can be read from the corresponding fields of the code points of the enhanced indexes.

In some cases, the code page information may not be embedded into the reserved fields of the code points, for example, if there are no such reserved fields in code points of a code page available. In such cases, the index generator 440 may provide the indexing information 450 to the index manger 450. The index manager 450 may store the indexing information 442 and code page information 456 in separated storage locations in the index storage system 405, as illustrated in FIG. 4. The code page information 456 is used to indicate the one or more code pages 422 that are identified to be associated with the document 402. In some embodiments, the indexing information 442 may be stored in an index storage area, and the code page information 456 may be in a remote storage repository in the index storage system 405 or other storage systems.

To associate the indexing information 442 with the code page information 456, the index manager 450 may further store association information to indicate an association between the indexing information 442 and the code page information 456. The association information may be stored in the index storage system 405 or other storage systems.

It should be appreciated that in some embodiments, the index manager 450 may be omitted from the system 400 if enhanced indexing information for a document can be generated.

By continuing to refer to the example documents and keywords in the example of FIG. 6A, some examples of associated storage of indexing information and code page information for documents are provided in FIGS. 6B and 6C.

FIG. 6B illustrates an example of generating enhanced indexing information in accordance with some embodiments of the present disclosure. As illustrated, an index table 652 includes enhanced indexing information generated for the document 402 as well as the documents 620 and 630. In this example and the following example illustrated in FIG. 6C, it is assumed that each index for a document includes a keyword extracted from the document. The indexing information for each of the documents 402, 620, and 630 may include a plurality of indexes. For example, the indexing information for the document 402 includes indexes with IDs 2, 4, 6, 7, and 10 contained in the index table 652.

In the example of FIG. 6B, an index extracted from a document is processed as an enhanced index by encoding the code page information in the reserved field(s) of the corresponding code points, to indicate the code page(s) associated with the document. As illustrated, an enhanced index 654 may comprise both the original index and the code page information. The keyword(s) in the index is represented by the predefined bits in the code point(s) of the default code page used for encoding indexing information, and the code page information is encoded into the reserved field(s) of the code point(s).

In the index table 652, an enhanced index 654 is mapped to a document identification which identifies the indexed document. For example, an enhanced index 654 with an index of “best” and “Windows-1252” is mapped to the document identification “620” for the document 620.

In the example of FIG. 6B, an enhanced index is generated for each index of the documents 402, 620, and 630. It should be appreciated that in other embodiments, the code page information may be encoded into a single or several indexes included in the indexing information of the document. When other indexes are searched, the code page information may be accessed from the single index or indexes for the same document.

FIG. 6C illustrates an example of storing the indexing information and the code page information in separated storage locations. In this example, an index table 660 includes indexing information generated for the document 402 as well as the documents 620 and 630. In the index table 660, each index for a document is further mapped to a document identification which identifies the indexed document. For example, an index of “best” is mapped to the document identification “620” for the document 620. In the illustrated example, for the purpose of brevity, the same indexes extracted from different documents may be recorded as a single index and mapped to the corresponding document identifications. For example, an index of “blue” is mapped to both document identifications “402” and “630” because this word is contained in both the documents 402 and 630.

In the example of FIG. 6C, a code page table 670 includes code page information for each of the documents 402, 620, and 630. The column of “Seg. ID” in the code page table 670 may indicate which segment in a corresponding document is encoded with the code page(s) indicated by the code page information. The notation of “Full” means that the whole document is encoded with the same code page. In some embodiments, the index table 660 and the code page table 670 may be stored in separate storage locations. As such, for a same document, its code page information and indexing information are stored as separate information. The document identifications mapped to the indexes in the index table 660 and the code page information in the code page table 670 that can help associate the code page information with indexing information are stored as separate information for the same documents.

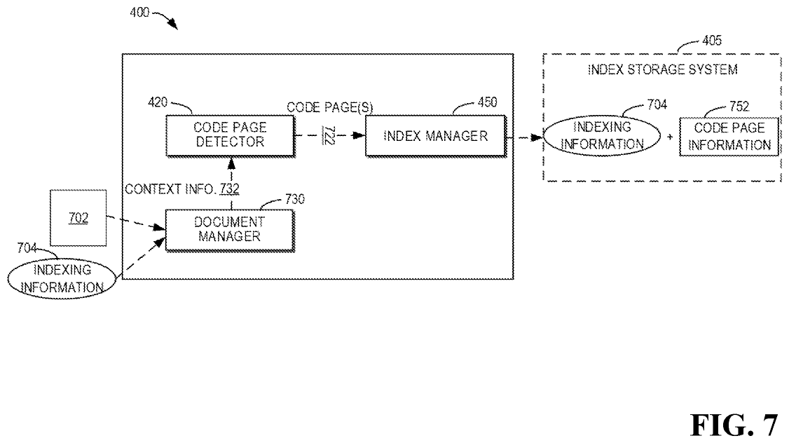

Tracking code page information when indexing new documents has been discussed in the above example embodiments. In some embodiments, for legacy indexing information, the system 400 may also be configured to determine and record the code pages associated with the documents indexed by the legacy indexing information. FIG. 7 illustrates such embodiments of the system 400. For the purpose of brevity, some components in the system 400 as illustrated in FIG. 4 are omitted from FIG. 7. In the example embodiments of FIG. 7, the system 400 further comprises a document manager 730.

The document manager 730 may be configured to retrieve indexing information 704, which has been generated and stored in the index storage system 405. The document manager 730 may determine and access a document 702 that is indexed by the indexing information 704. The indexing information 704 may include one or more indexes extracted from the document 702. The access of the document 702 is to determine one or more code pages associated with the document 702. In some embodiments, the document manager 730 may detect or obtain context information 732 associated with the document 702, and provide the context information 732 to the code page detector 420.

Based on the context information 732, the code page detector 420 may determine the current code page used for encoding the document 702 and probably determine one or more historical code pages that were previously used for encoding the document 702. In some embodiments, the code page detector 702 may further identify an indexing code page that is used for encoding the indexing information 704, which may be a default code page for the system 400.

The code page detector 420 may provide the identified code page(s) 722 associated with the document 702 to the index manager 450. The index manager 450 may store code page information 752 in association with the indexing information 704. The code page information 752 may indicate the identified code page(s) 722. The storing of the code page information 752 and the indexing information 704 may be performed in a similar way as discussed above with reference to FIG. 4 and FIG. 6C. In some other embodiments, although not illustrated in FIG. 7, the index generator 450 in the system 400 may be configured to modify the indexing information 704 that is stored in the index storage system 405, to encode the code page information 752 into the indexes of the indexing information 704 if there are reversed fields in code points representing the indexes. That is, the indexing information 704 may be modified to enhanced indexing information, with the code page information embedded therein.

The indexing of documents has been discussed above. The stored indexing information and the code page information for one or more documents may be utilized for document searching. Reference is made back to FIG. 4. The searching part of the system 400 may comprise a query parser 460 and a query manager 470. The query parser 460 and the query manager 470 may be configured to receive a search query 462. The search query 462 may include one or more keywords and/or characters. In response to the search query 462, the query parser 460 and the query manager 470 may operate to determine a query result 472 for the search query 462.

The query result 472 may indicate one or more documents that are found to be relevant to the search query 462. A relevant document may be referred to as a hit for the search query 462. If no relevant document is found, the query result 472 may indicate that no hit is found.

Generally, indexing information is created to accelerate to the searching process for relevant documents for search queries. A search query is compared with the indexing information, or more specifically, the respective indexes included in the indexing information. If one or more keywords in a search query matches with the indexes for a document, it is believed that this document is relevant to the search query.

During the searching process, a relevance degree may be determined to measure to which extent an indexed document is relevant to the received search query. According to the embodiments of the present disclosure, in addition to indexing information for a document, stored code page information for the document is also used to determine the relevance degree between the document and the search query. If the relevance degree determined for a document is relatively high or higher than one or more other documents, this document may be determined as relevant to the search query 462 and thus may be indicated in the query result 472.

In the system 400 of FIG. 4, take the document 402 as an example, of which the enhanced indexing information 452 or the associated indexing information 442 and code page information 456 are stored in the index storage system 405. To determine a relevance degree between the document 402 and the search query, the query parser 460 may identify a target code page used for encoding the search query 462. In some embodiments, the query parser 460 may obtain context information associated with the search query 462 and provide the context information to the code page detector 420 to determine the target code page. The code page detector 420 may determine the target code page utilizing some ways similar to the ways for determining the code page(s) associated with a document. The target code page may be determined or specified in other manners and the scope of the present disclosure is not limited in this regard.

In some embodiments, the query parser 460 may indicates the target code page 464 of the search query 462 to the query manger 470. Upon receipt of the search query 462, the query manager 470 may compare the search query 462 with the indexing information 442 or the enhanced indexing information 452 (more specifically, the part of the indexing information) for the document 402 (and possibly one or more other documents indexed in the index storage system 405. The keyword(s) contained in the search query 462 may be compared against the keyword(s) in the index(es) of the indexing information 442 or the enhanced indexing information 452.

In the cases where the enhanced indexing information 452 is used, the query manager 470 may decode the code page information and the indexing information from the enhanced indexing information. As described above, the code page information may be encoded in the reserved fields of the code points and the indexing information may be encoded in the code points as defined in the indexing code page. The query manager 470 may decode the corresponding code page information and the indexing information from the corresponding fields of the code points.

If the indexing information for the document 402 matches with the search query 462, the query manager 470 may further rely on the code page information for the document 402 to determine or adjust a relevance degree between the document 402 and the search query 462. In some embodiments, if one or more indexes in the indexing information for the document 402 are determined to be the same as or similar to one or more of the keyword(s) in the search query 462, the query manager 470 may determine that the indexing information and the search query 462 match each other.

In some embodiments, if the indexing information and the search query 462 match each other, the query manager 470 may further compare the target code page with the code page(s) indicated by the code page information 456 or the one embedded in the enhanced indexing information 452, and determine the relevance degree between the document 402 and the search query 462 based on a result of the comparison.

The result of the comparison between the target code page and the code page(s) associated with the document 402 may be applied in different ways to determine the relevance degree between the document 402 and the search query 462.

In some embodiments, a base relevance degree between the document 402 and the search query 462 may be determined based on the result of comparing the search query 462 with the indexing information for the document 402. For example, the more the keyword(s) in the search query 462 match with the index(es) of the indexing information, the higher the base relevance degree may be set. Further, the base relevance degree may be increased if the target code page matches with one of the code page(s) associated with the document 402. Otherwise, the base relevance degree may be decreased due to a mismatch between the target code page with the code page(s) associated with the document 402. The increased or decreased base relevance degree may be determined as the final relevance degree for the document 402.

In some embodiments, the code page information may be used to differentiate a plurality of documents that are found to be relevant to the search query 462 due to the matching between the search query 462 with the indexing information of those documents. For example, if the search query 462 matches with the indexing information of the document 402 and one or more other documents (not shown in FIG. 4), the query manager 470 may compare the target code page with the code pages associated with those documents (including the document 402).

Depending on whether the target code page matches with any code pages of the documents, different weights may be assigned to the documents. For example, if the target code page for the search query 462 matches with a code page of the document 402 but mismatches with a code page of another document, a first weight may be assigned to the document 402 while a second weight may be assigned to the other document, where the first weight may be higher than the second weight. The weight assignment may indicate the relevance between the documents and the search query 462 in terms of code page. In some embodiments, the first weight assigned to the document 402 may be applied to the base relevance degree that is determined for the document 402 based on the matching result of the search query 462 with the indexing information for the document 402, so as to calculate a weighted relevance degree for the document 402. The second weight may be similarly applied to determine a weighted relevance degree for the other document.

In some embodiments, the relevance degrees determined for the documents (including the document 402) may be utilized to determine whether the corresponding documents may be indicated by the query result 472 as relevant to the search query 462, and/or to rank the documents when presenting them to the user.

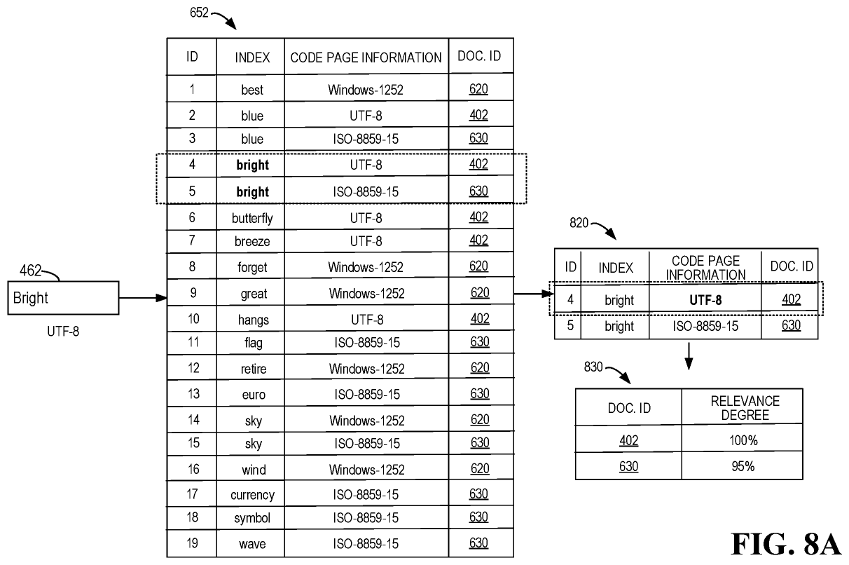

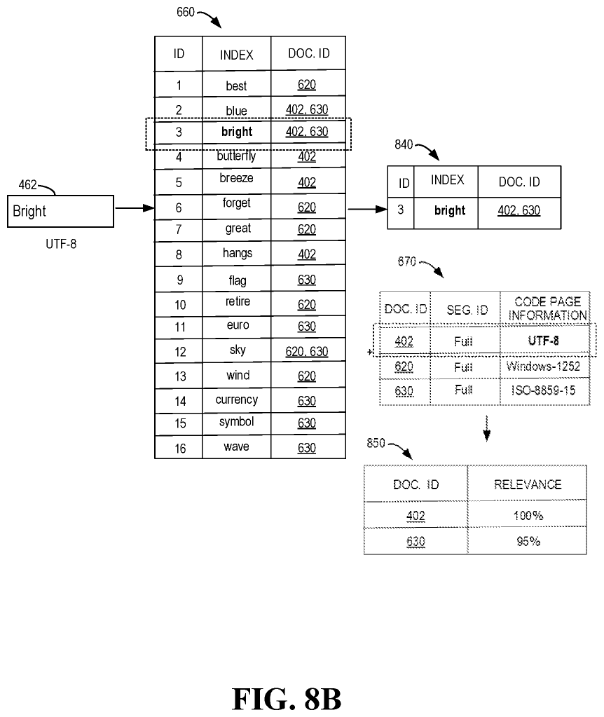

To better understand the searching process, reference is made to some specific examples illustrated in FIG. 8A and FIG. 8B. In the example of FIG. 8A, the searching is performed against enhanced indexing information built for one or more documents. For the purpose of illustration, the index table 652 of FIG. 6B is still taken as an example, which includes the enhanced indexing information stored for the document 402, 620, and 630. It is assumed that the search query 462 includes a keyword of “bright” and its target code page is “UTF-8.”

By comparing the search query 462 with the indexing information embedded in the enhanced indexing information, the query manager 470 may determine that indexes of “bright” for both the documents 402 and 630 matches with the search query 462. The query manager 470 may extract, from the index table 652, an enhanced index for the document 402 with an index of “bright” and an enhanced index for the document 630 with the same index. The two enhanced indexes are recorded in an index subset 820. In addition to the index of “bright”, the enhanced indexes further indicate the code page information for the documents 402 and 630.

Thus, the query manager 470 may compare the target code page for the search query 462 with the code pages indicated by the code page information for the documents 402 and 630. The query manager 470 determines that the target code page of “UTF-8” matches with a code page associated with the document 402 but mismatches with the code page associated with the document 630. Based on the match result, the query manager 470 may determine the relevance degrees for the documents 402 and 630.

In some embodiments, due to the matching of the search query 462 with the indexes of both the documents 402 and 630, the base relevance degrees for the two documents are both 100%. As the document 402 is encoded with the same code page as the search query 462, a weight of “1” may be assigned to the document 402. As the document 630 is encoded with a different code page than the one used for encoding the search query 462, a weight of “0.95” may be assigned to the document 630. By weighting the base relevance degrees with the assigned weights, the relevance degrees for the documents 402 and 630 are calculated as illustrated in a relevance degree table 830. As such, the document 402, which contains the same keyword and is encoded with the same code page as the search query 462, may be provided as a search result and/or may be ranked in a higher position than the document 630.

FIG. 8B illustrates a searching process performed against separated storage of indexing information and code page information for one or more documents. For the purpose of illustration, the index table 660 and the code page table 670 of FIG. 6C are still taken as an example, which include the indexing information and code page information respectively to the document 402, 620, and 630. It is still assumed that the search query 462 includes a keyword of “bright,” and its target code page is “UTF-8.”

By comparing the search query 462 with the indexing information embedded in the enhanced indexing information, the query manager 470 may determine that the index of “bright” stored for both the documents 402 and 630 matches with the search query 462. The query manager 470 may extract, from the index table 660, an index subset 840 including the matched index of “bright” and the document identifications of the documents 402 and 630 indexed by this index. The query manager 470 may further access the code page table 670. According to the document identifications of the document 402 and 630 in the index subset 840, the query manager 470 may be able to locate the associated code page information for the two documents 402 and 630 in the code page table 670.

The query 470 may compare the target code page for the search query 462 with the code pages indicated by the code page information for the documents 402 and 630. The query manager 470 determines that the target code page of “UTF-8” matches with a code page associated with the document 402 but mismatches with the code page associated with the document 630. Based on the match result, the query manager 470 may determine the relevance degrees for the documents 402 and 630, as illustrated in a relevance degree table 850. In the relevance degree table 850, the document 402 is determined to have a higher relevance degree than the document 630 because of the same code page as the one used for the search query 462. The determination of the relevance degrees may be similar as discussed with reference to FIG. 8A above.

In some cases, in addition to the current code page for the document 402, the code page information may record one or more historical code pages used for encoding the document 402, and/or the indexing code page used for encoding the indexing information. The match or mismatch of the target code page with different code pages may have different impacts on the relevance degree for the document 402.

For example, a match of the target code page with the current code page for the document 402 may cause a weight of a larger value assigned to the document 402 than a match of the target code page with a historical code page or the indexing code page used for encoding the indexing information for the document 402. As another example, a match of the target code page with a historical code page for the document 402 may cause a weight of a larger value assigned to the document 402 than a match of the target code page with the indexing code page used for encoding the indexing information for the document 402. In some examples, matches of the target code page with a plurality of historical code pages may cause different weights assigned to the document 402, where a weight of a smaller value may be assigned in the case of a match of the target code page with an earlier historical code page.

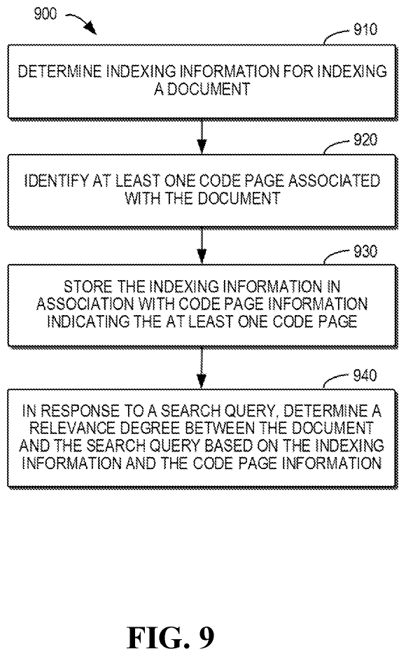

FIG. 9 shows a flowchart of an example method 900 in accordance with some embodiments of the present disclosure. The method 900 can be implemented at the system 400. For the purpose of discussion, the method 900 will be described from the perspective of the system 400.

At block 910, the system 400 determines indexing information for indexing a document, the indexing information comprising at least one index extracted from the document. At block 920, the system 400 identifies at least one code page associated with the document. At block 930, the system 400 stores the indexing information in association with code page information indicating the at least one code page. At block 940, in response to a search query, the system 400 determines a relevance degree between the document and the search query based on the indexing information and the code page information.

In some embodiments, identifying the at least one code page associated with the document comprises: in response to an indexing request for the document, determining context information associated with at least one of: the indexing request, a requestor initiating the indexing request, and the document; and determining at least one code page associated with the document based on the context information.

In some embodiments, identifying the at least one code page associated with the document comprises: obtaining metadata associated with the document, the metadata indicating at least one code page used for encoding the document.

In some embodiments, an index of the indexing information is encoded with at least one code point from an indexing code page used for encoding the indexing information. In some embodiments, storing the indexing information in association with the code page information comprises: determining whether there is a reserved field in the at least one code point of the index of the indexing information; in accordance with a determination that there is the reserved field in the at least one code point, generating enhanced indexing information by encoding the code page information into the reserved field of the at least one code point; and storing the enhanced indexing information for the document.

In some embodiments, determining the relevance degree comprises: decoding the indexing information and the code page information from the enhanced indexing information; and determining the relevance degree based on the decoded indexing information and the decoded code page information.

In some embodiments, storing the indexing information in association with the code page information comprises: storing the indexing information and the code page information in separated storage locations; and storing association information between the indexing information and the code page information.

In some embodiments, determining the relevance degree comprises: comparing the search query with the indexing information; in accordance with a determination that the indexing information matches with the search query, identifying a target code page used for encoding the search query; comparing the target code page with the at least one code page indicated by the code page information; and determining the relevance degree between the document and the search query based on a result of the comparison.

In some embodiments, a further document is indexed with further indexing information that is stored in association with further code page information indicating at least one further code page. In some embodiments, determining the relevance degree between the document and the search query based on a result of the comparison comprises: in accordance with a determination that the indexing information and the further indexing information both match with the search query, comparing the target code page with the code pages indicated by the indexing information and the further indexing information; in accordance with a determination that the target code page matches with a code page indicated by the indexing information and mismatches with a code page indicated by the further indexing information, assigning a first weight to the document, the first weight being higher than a second weight to be assigned to the further document; and determining the relevance degree between the document and the search query based on the first weight.

In some embodiments, the at least one code page comprises a current code page used for encoding the document, a historical code page used for encoding the document, and an indexing code page used for encoding the indexing information.

In some embodiments, assigning the first weight to the document comprises in accordance with a determination that the target code page matches with the current code page, determining the first weight to be a first value, in accordance with a determination that the target code page matches with the historical code page, determining the first weight to be a second value lower than the first value, and in accordance with a determination that the target code page matches with the indexing code page, determining the first weight to be a third value lower than the second value.

It should be noted that the processing of indexing and searching according to embodiments of this disclosure could be implemented by computer system/server 12 of FIG. 1.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method comprising:
determining, by one or more processors, indexing information for indexing a document, the indexing information comprising at least one index extracted from the document;
identifying, by one or more processors, at least one code page associated with the document;
storing, by one or more processors, the indexing information in association with code page information indicating the at least one code page; and
in response to a search query, determining, by one or more processors, a relevance degree between the document and the search query based on the indexing information and the code page information.

2. The method of claim 1, wherein identifying the at least one code page associated with the document comprises:
in response to an indexing request for the document, determining, by one or more processors, context information associated with at least one of the indexing request, a requestor initiating the indexing request, and the document; and
determining, by one or more processors, at least one code page associated with the document based on the context information.

3. The method of claim 1, wherein identifying the at least one code page associated with the document comprises:
obtaining, by one or more processors, metadata associated with the document, the metadata indicating at least one code page used for encoding the document.

4. The method of claim 1, wherein an index of the indexing information is encoded with at least one code point from an indexing code page used for encoding the indexing information, and storing the indexing information in association with the code page information comprises:
determining, by one or more processors, whether there is a reserved field in the at least one code point of the index of the indexing information;
in accordance with a determination that there is the reserved field in the at least one code point, generating, by one or more processors, enhanced indexing information by encoding the code page information into the reserved field of the at least one code point; and
storing, by one or more processors, the enhanced indexing information for the document.

5. The method of claim 4, wherein determining the relevance degree comprises:
decoding, by one or more processors, the indexing information and the code page information from the enhanced indexing information; and
determining, by one or more processors, the relevance degree based on the decoded indexing information and the decoded code page information.

6. The method of claim 1, wherein storing the indexing information in association with the code page information comprises:
storing, by one or more processors, the indexing information and the code page information in separated storage locations; and
storing, by one or more processors, association information between the indexing information and the code page information.

7. The method of claim 1, wherein determining the relevance degree comprises:
comparing, by one or more processors, the search query with the indexing information;
in accordance with a determination that the indexing information matches with the search query, identifying, by one or more processors, a target code page used for encoding the search query;
comparing, by one or more processors, the target code page with the at least one code page indicated by the code page information; and
determining, by one or more processors, the relevance degree between the document and the search query based on a result of the comparison.

8. The method of claim 7, wherein a further document is indexed with further indexing information that is stored in association with further code page information indicating at least one further code page, and determining the relevance degree between the document and the search query based on a result of the comparison comprises:
in accordance with a determination that the indexing information and the further indexing information both match with the search query, comparing, by one or more processors, the target code page with the code pages indicated by the indexing information and the further indexing information separately;
in accordance with a determination that the target code page matches with a code page indicated by the indexing information and mismatches with a code page indicated by the further indexing information, assigning, by one or more processors, a first weight to the document, the first weight being higher than a second weight to be assigned to the further document; and
determining, by one or more processors, the relevance degree between the document and the search query based on the first weight.

9. The method of claim 8, wherein the at least one code page comprises a current code page used for encoding the document, a historical code page previously used for encoding the document, and an indexing code page used for encoding the indexing information, and
wherein assigning the first weight to the document comprises:
in accordance with a determination that the target code page matches with the current code page, determining the first weight to be a first value,
in accordance with a determination that the target code page matches with the historical code page, determining the first weight to be a second value lower than the first value, and
in accordance with a determination that the target code page matches with the indexing code page, determining the first weight to be a third value lower than the second value.

10. A system comprising:
a processing unit; and
a memory coupled to the processing unit and storing instructions thereon, the instructions, when executed by the processing unit, performing acts including:
determining indexing information for indexing a document, the indexing information comprising at least one index extracted from the document;
identifying at least one code page associated with the document;
storing the indexing information in association with code page information indicating the at least one code page; and
in response to a search query, determining a relevance degree between the document and the search query based on the indexing information and the code page information.

11. The system of claim 10, wherein identifying the at least one code page associated with the document comprises:
in response to an indexing request for the document, determining context information associated with at least one of the indexing request, a requestor initiating the indexing request, and the document; and
determining at least one code page associated with the document based on the context information.

12. The system of claim 10, wherein identifying the at least one code page associated with the document comprises:
obtaining metadata associated with the document, the metadata indicating at least one code page used for encoding the document.

13. The system of claim 10, wherein an index of the indexing information is encoded with at least one code point from an indexing code page used for encoding the indexing information, and storing the indexing information in association with the code page information comprises:
determining whether there is a reserved field in the at least one code point of the index of the indexing information;
in accordance with a determination that there is the reserved field in the at least one code point, generating enhanced indexing information by encoding the code page information into the reserved field of the at least one code point; and
storing the enhanced indexing information for the document.

14. The system of claim 13, wherein determining the relevance degree comprises:
decoding the indexing information and the code page information from the enhanced indexing information; and
determining the relevance degree based on the decoded indexing information and the decoded code page information.

15. The system of claim 10, wherein determining the relevance degree comprises:
comparing the search query with the indexing information;
in accordance with a determination that the indexing information matches with the search query, identifying a target code page used for encoding the search query;
comparing the target code page with the at least one code page indicated by the code page information; and
determining the relevance degree between the document and the search query based on a result of the comparison.

16. The system of claim 15, wherein a further document is indexed with further indexing information that is stored in association with further code page information indicating at least one further code page, and determining the relevance degree between the document and the search query based on a result of the comparison comprises:
in accordance with a determination that the indexing information and the further indexing information both match with the search query, comparing the target code page with the code pages indicated by the indexing information and the further indexing information separately;
in accordance with a determination that the target code page matches with a code page indicated by the indexing information and mismatches with a code page indicated by the further indexing information, assigning a first weight to the document, the first weight being higher than a second weight to be assigned to the further document; and
determining the relevance degree between the document and the search query based on the first weight.

17. The system of claim 16, wherein the at least one code page comprises a current code page used for encoding the document, a historical code page used for encoding the document, and an indexing code page used for encoding the indexing information, and wherein assigning the first weight to the document comprises:
in accordance with a determination that the target code page matches with the current code page, determining the first weight to be a first value,
in accordance with a determination that the target code page matches with the historical code page, determining the first weight to be a second value lower than the first value, and
in accordance with a determination that the target code page matches with the indexing code page, determining the first weight to be a third value lower than the second value.

18. A computer program product comprising a computer readable storage medium having program instructions embodied therewith, the program instructions executable by a processor to cause the processor to perform operations, the operations comprising:
determining indexing information for indexing a document, the indexing information comprising at least one index extracted from the document;
identifying at least one code page associated with the document;
storing the indexing information in association with code page information indicating the at least one code page; and
in response to a search query, determining a relevance degree between the document and the search query based on the indexing information and the code page information.

19. The computer program product of claim 18, wherein determining the relevance degree comprises:
comparing the search query with the indexing information;
in accordance with a determination that the indexing information matches with the search query, identifying a target code page used for encoding the search query;
comparing the target code page with the at least one code page indicated by the code page information; and
determining the relevance degree between the document and the search query based on a result of the comparison.

20. The computer program product of claim 19, wherein a further document is indexed with further indexing information that is stored in association with further code page information indicating at least one further code page, and determining the relevance degree between the document and the search query based on a result of the comparison comprises:
in accordance with a determination that the indexing information and the further indexing information both match with the search query, comparing the target code page with the code pages indicated by the indexing information and the further indexing information separately;
in accordance with a determination that the target code page matches with a code page indicated by the indexing information and mismatches with a code page indicated by the further indexing information, assigning a first weight to the document, the first weight being higher than a second weight to be assigned to the further document; and
determining the relevance degree between the document and the search query based on the first weight.
